(19) United States
(12) Patent Application Publication
(10) Pub. No.: US 2006/0068148 A1
(43) Pub. Date: Mar. 30, 2006

(54) Adhesive strip for forming a reminder rib in a grip

(75) Inventor: James Jay Ulrich, Southern Pines, NC (US)

Correspondence Address: EATON CORPORATION;EATON CENTER, 1111 SUPERIOR AVENUE, CLEVELAND, OH, 44114, US

(73) Assignee: Eaton Corporation, Cleveland, OH (US)

(21) Appl. No.: 10/950,836

(22) Filed: Sep. 27, 2004

(51) Int. Cl. B32B 3/00; B32B 37/00

(52) U.S. Cl. 428/41.8; 428/161; 473/303; 156/294

(57) ABSTRACT

An adhesive strip (32) for installation of a grip (10) on a shaft (12) forms a reminder rib (38) in a desired location. The adhesive strip (32) is particularly suited for forming a reminder rib (38) in a golf club grip.

### BACKGROUND OF THE INVENTION

1. Field of the Invention

The present invention relates in general to a new and improved adhesive strip for forming a reminder rib in a grip, and more particularly to an adhesive strip for providing a reminder rib on a golf club grip after installation on a golf club shaft.

2. Description of the Related Art

The United States Golf Association has a set of rules for golf that requires grips on any golf clubs other than putters to be circular in cross-section. This rule does create an exception in that a continuous, straight, slightly raised rib may be incorporated along the full length of the grip. This rib is often referred to as a “reminder” rib. The reminder rib assists the golfer in quickly identifying hand position on the grip as well as proper positioning of the hands for the grip. The rules of golf interpret the term “slightly raised” as meaning that the maximum and minimum diameters of the cross-section at any point of the grip must not differ by more than about 0.04 inches or about 1 millimeter (mm) for these types of golf grips. As stated in the golf rules, this measurement is taken using a pair of calipers. A standard length golf grip is approximately 10 inches in length and the term “full length of the grip” is interpreted to mean that the rib must extend to within 3 inches of the tip. This is the portion of the golf grip closest to the club face. This is considered sufficient to cover the span of a golfer's hand on the grip.

While some golfers and club makers prefer to use a grip that is simply round, or circular in cross-section, there are those who do prefer a grip with the reminder rib. The golf grip manufacturers and suppliers try to accommodate customers in both of these market segments by making and stocking grip models in both forms. One form has the round core or wall section. The other form has a ribbed core or one formed by an inner wall with a flat on one side to cause the protruding slightly raised rib once the grip is installed on the club shaft. Manufacturing and maintaining an inventory of these two separate grip models adds complexity and costs to the golf grip manufacturers and suppliers businesses.

Thus, it is desirable to have a simple cost effective way for installing a reminder rib on just one type of golf grip. Preferably, the method of installation and device for installation would not require manufacturing different forms of grips that require separate molds and tooling, or keeping or maintaining inventories of the separate types of golf club grips.

### BRIEF SUMMARY OF THE INVENTION

Accordingly, an object of the present invention is to provide a new method for forming a reminder rib on a grip.

Another object of the present invention is to provide a new and improved adhesive strip for installation of a grip on a shaft that forms a ridge extending longitudinally on the grip that functions as a reminder rib.

Still another object of the present invention is to provide a method for forming a reminder rib on a golf club grip that complies with the United States Golf Association rules of golf.

The above and other objects of the present invention are accomplished with an adhesive strip that comprises a material constructed to form a ridge extending longitudinally on the adhesive portion of the strip. The material is preferably a substantially cylindrical material such as a wire or line. The present invention also comprises a method for forming a reminder rib on a grip employing such a new and improved adhesive tape.

The various features of novelty which characterize the invention are pointed out with particularity in the claims annexed to and forming a part of this disclosure. For a better understanding of the invention, its operating advantages, and specific objects attained by its uses, reference is made to the drawings, and descriptive matter in which a preferred embodiment of the invention is described and illustrated.

### BRIEF DESCRIPTION OF THE DRAWINGS

FIG. 1 is an elevated frontal sectional view of a golf club grip on a shaft;

FIG. 2 is a perspective view of a double sided adhesive tape employed for installing a golf club grip;

FIG. 3 is a sectional view taken along lines 2-2 of a prior art golf grip that is round or circular in cross section;

FIG. 4 is a sectional view similar to that shown in FIG. 2 of a prior art golf club grip designed to create a reminder rib;

FIG. 5 is a perspective view of a double sided adhesive strip in accordance with a preferred embodiment of the present invention constructed to form a reminder rib in a grip; and

FIG. 6 is a sectional view similar to FIGS. 3 and 4 illustrating the formation of the reminder rib in the golf club grip.

### DETAILED DESCRIPTION OF THE INVENTION

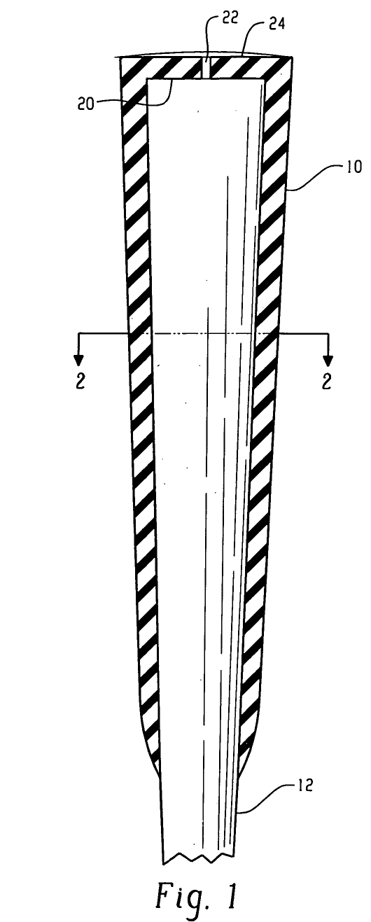

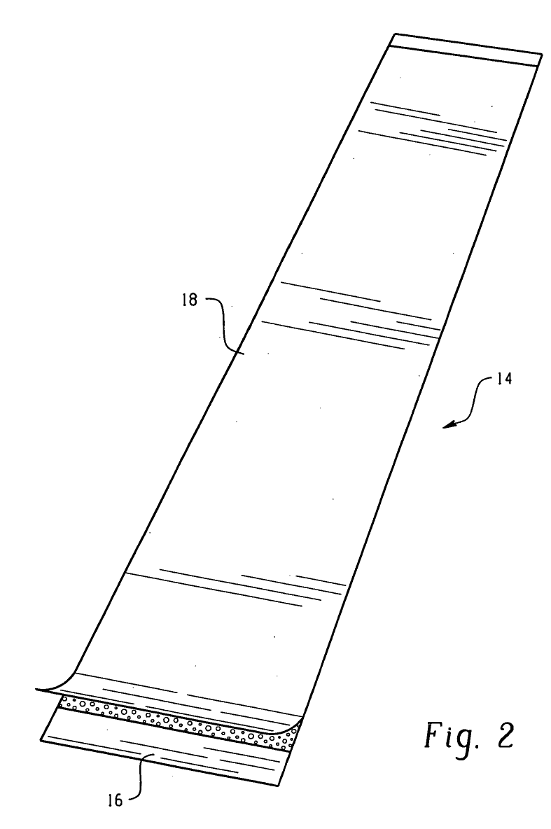

Referring to the figures, which are not intended to limit the present invention thereto, and where like numerals designate like or similar features throughout the several views, and first in particular to FIG. 1, there is shown a sectional view of a golf club grip 10 positioned on a golf club shaft 12. Golf club grip club 10 is what is known in the art as a slip-on style golf club grip. The term “slip-on” as employed herein is intended to refer to a grip that is designed to slide onto a handle or shaft 12 and be secured thereto. These types of grips use a plain, flat double-sided adhesive tape 14 as shown in FIG. 2. Adhesive tape 14 is well known and commonly used in the re-gripping of golf club grips. The double-sided adhesive tape 14 includes lower and upper backing strips 16, 18 for facilitating installing the tape on the shaft 12 and then grip 10 thereon.

When a golf club is going to be re-gripped, the golf club is secured in a vice and the old grip 10 is removed from the shaft 12. The old adhesive or tape is carefully removed and the shaft 12 is wiped clean with a solvent. The double-sided adhesive tape has its lower or inside backing 16 removed and is placed on the shaft 12 allowing for some overhang at the butt end 20 of the shaft. The upper backing 18 which is the outside backing of the tape 14 is removed. A solvent or some other type of activating solution is generously applied over the entire adhesive tape surface. An opening 22 in the grip end is used for placing solvent inside the grip 10 where it is evenly distributed within the grip 10. The grip is then aligned and pushed over the end of the shaft 12 until the grip end 24 is firmly pressed or sealed against the butt end 20 of the shaft. Typically, the grip 10 is allowed to set overnight prior to use to allow the adhesive to firmly secure the grip 10 to the shaft 12. This procedure for re-gripping a golf club is well known in the art for slip-on style golf grips.

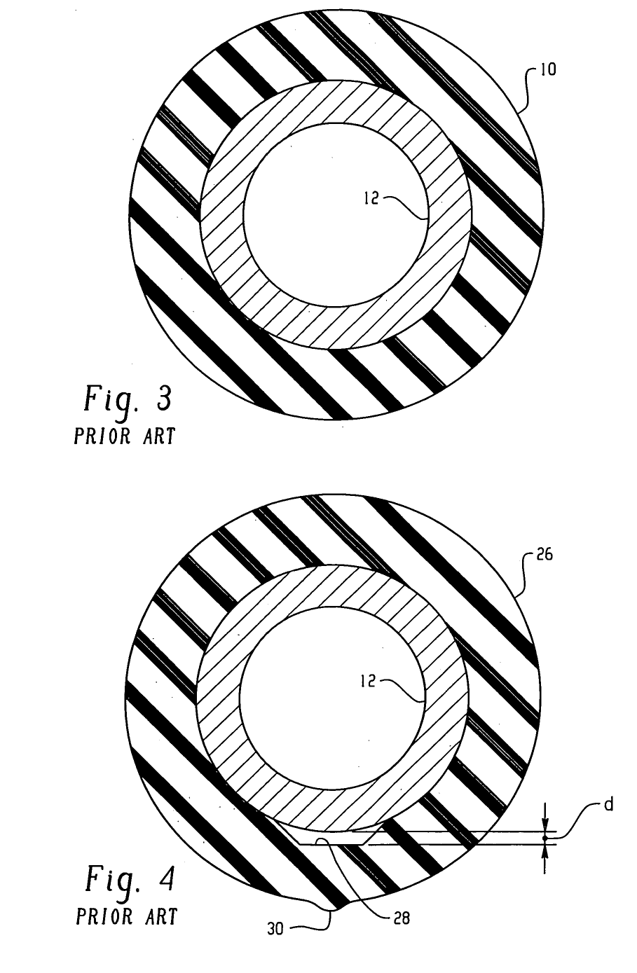

Referring next to FIG. 3, there is shown a sectional view of grip 10 on shaft 12. This grip 10 is depicted as round or circular with no slightly raised reminder rib. Some golfers prefer this type of grip and have no need for a reminder rib for hand placement. This is referred to as a standard slip-on molded rubber golf grip. Some styles of these grips have a rubber underlayer or underlisting and include a polyurethane wrap for a different grip feel.

Next, referring to FIG. 4, there is depicted a sectional view of another form of prior art golf club grip described briefly previously. This grip 26 is installed on golf club shaft 12 in the same manner as was described with respect to the grip 10 shown in FIGS. 1 and 3. In contrast to grip 10, grip 26 includes a flat indentation 28 with a depth (d) which upon installation on shaft 12 forms a reminder rib 30 as seen in FIG. 4. The grips 10, 26 are manufactured differently and require different tooling. Additionally, suppliers must stock two separate types of inventory.

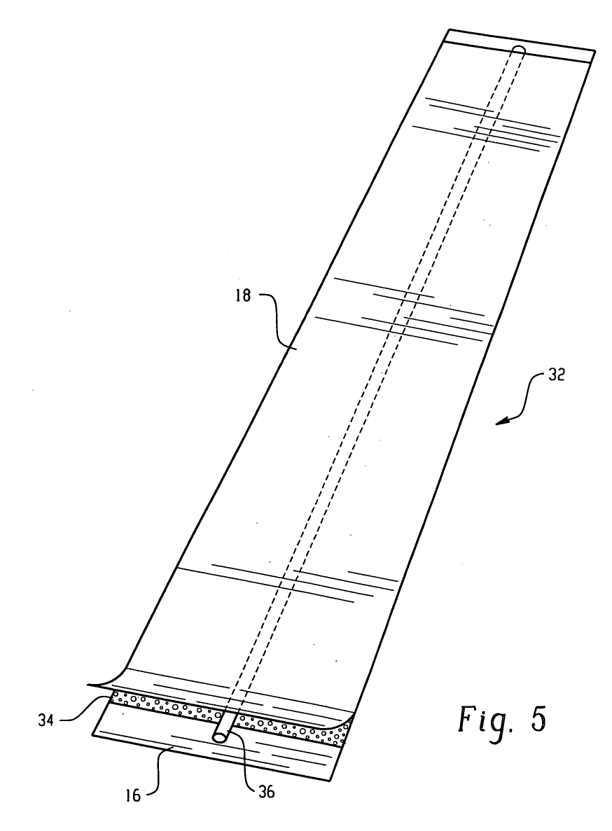

The present invention resides in a simple, cost effective manner of forming a reminder rib without requiring separate tooling, separate molding processes, or keeping separate inventory. The present invention can be employed with a standard type of golf club grip having a cross-section as seen in FIG. 3 and will upon installation form a reminder rib. Turning now to FIG. 5, there is shown an adhesive strip 32 in accordance with the present invention. Adhesive strip 32 includes an adhesive portion 34 with lower and upper backing strips 16, 18. Positioned between the lower and upper backing strips 16, 18 is a material 36, which is preferably substantially cylindrical, and more preferably a wire or line extending lengthwise along strip 32. Preferably, the wire is stainless steel and is positioned fairly centrally on adhesive portion 34 or even within adhesive portion 34.

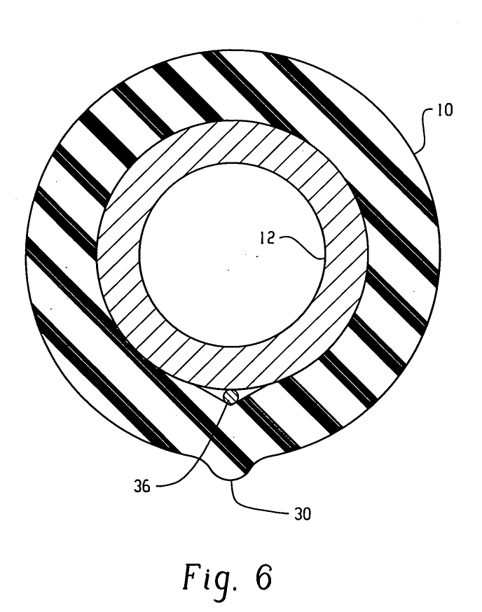

Referring next to FIG. 6, there is depicted a sectional view of a grip 10 similar to FIG. 3 except for the use of the adhesive strip 32 in accordance with the present invention. The manner of installation of grip 10 on shaft 12 as seen in FIG. 6 is similar to that previously described with respect to FIG. 3, except for the use of adhesive strip 32, instead of adhesive tape 14. Wire 36 is located preferably on the underside of shaft 12 so that a reminder rib 38 is formed on the underside of grip 10. This is normally the desired location for the reminder rib on a golf grip.

In this manner, the adhesive strip 32 in accordance with the present invention allows a conventional molded rubber grip 10 or any circular round grip made of any material to be utilized on a golf club shaft and be used to form a reminder rib 38. Similarly, adhesive strip 32 according to the present invention may be used with a wrap style grip, one that simply wraps a gripping material around a shaft, in a similar manner to form a reminder rib.

The United States Golf Association rules require a reminder rib not to be greater than about 0.04 inches or about 1 millimeter. Advantageously, with the present invention, any type of wire or line including, for example, a monofilament fishing line can be used. Preferably, the diameter is equal to or less than 0.04 inches or 1 millimeter to comply with the golf rules. More preferably a hard, stainless steel wire is used. While the drawings depict a substantially cylindrical material, it should be understood that alternate embodiments of the material 36 may include a wide variety of shapes, for example, a square material will create a gradual profile of the rubber wall thickness of the grip to form a reminder grip. While the present invention is particularly suited for use with a golf club grip and has been described in particular for that purpose, the present invention should not be limited thereto. The present invention can be used on other types of hand grips that desire a slightly raised ridge or a reminder rib.

A significant advantage of the present invention is that it allows the use of a fully round or circular grip to satisfy the installation preference for either those users who desire or do not desire use of a reminder rib. For those who desire a grip without a reminder rib, a conventional adhesive tape is employed. On the other hand, for those who desire a reminder rib in the grip the adhesive strip 32 in accordance with the present invention is employed. Vendors and installers of these grips benefit from the reduced inventory as well as the manufacturers or suppliers benefit by no longer requiring special tooling, molding or manufacturing processes.

While specific embodiments of the invention have been shown and described in detail to illustrate the application of the principles of the invention, it will be understood that the invention may be embodied otherwise without departing from such principles.

I claim:

1. In an adhesive strip (32) for installation of a grip (10) on a shaft (12), the improvement comprises an improved adhesive strip (32) having a material (36) extending longitudinally on the adhesive portion (34) constructed to form a ridge (38).

2. An improved adhesive strip (32) according to claim 1, wherein said material (36) comprises a wire.

3. An improved adhesive strip (32) according to claim 1, wherein said material (36) comprises a substantially cylindrical material (36).

4. An improved adhesive strip (32) according to claim 3, wherein said substantially cylindrical material (36) comprises an elastomeric line.

5. An improved adhesive strip (32) according to claim 3, wherein said substantially cylindrical material comprises a diameter not greater than about 1 millimeter.

6. An improved adhesive strip (32) according to claim 1, wherein said adhesive portion (34) comprises a double-sided adhesive portion with a lower and an upper backing strip (16, 18) used for installing a golf club grip (10) on a golf shaft (12).

7. A method for forming a reminder rib (38) on a grip (10), comprising the steps of:
providing an adhesive strip (32) with a material (36) constructed to form a ridge (38) extending along said adhesive strip (32);
applying said adhesive strip (32) on a shaft (12);
activating the adhesive portion (34) on said adhesive strip (32);
aligning a grip (10) in an arrangement that situates said adhesive strip (32) with the material (36) constructed to form a ridge (38) is disposed in a desired location; and
placing said grip (10) over said adhesive strip (32) on said shaft (12).

8. A method according to claim 7, wherein said shaft (12) comprises a golf club shaft.

9. A method according to claim 8, wherein said providing step further comprises the step of disposing a substantially cylindrical material (36) on said adhesive strip.

10. A method according to claim 9, wherein said substantially cylindrical material (36) comprises a diameter equal to or less than one millimeter.

11. A method according to claim 10, wherein said substantially cylindrical materials comprises wire.

12. A method according to claim 11, wherein said substantially cylindrical material (36), comprises an elastomeric line.
